(19) United States
(12) Patent Application Publication
(10) Pub. No.: US 2007/0239461 A1
(43) Pub. Date: Oct. 11, 2007

(54) Interactive package system

(76) Inventors: Michael Poninski, Montreal (CA); John Cattley, Contrecoeur (CA)

Correspondence Address: SNIDER & ASSOCIATES, P. O. BOX 27613, WASHINGTON, DC, 20038-7613, US

(21) Appl. No.: 11/400,235

(22) Filed: Apr. 10, 2006

(51) Int. Cl. G10L 21/00

(52) U.S. Cl. 704/500

(57) ABSTRACT

The present invention provides a package which includes a container and structure within such container to hold storage media or a product including such storage media therewithin. An audio system is operatively associated with the exterior of such package. The audio system includes a self-contained electrical power source and a single “on/off” switch which is electrically connected to the electrical power source. A speaker is connected to the controller/memory circuit A read/write controller/memory circuit is electrically connected to the on/off switch. Such circuit includes a software playback processor and is uploaded with a plurality of selected sound files which are intimately associated with, but are separate and distinct from, the storage media or the product including the storage media which is in the package. The processor/memory thus is uploaded with a software playback program. Such playback program is manually actuated by means of such single “on/off” switch to effect one of a series of particularly-specified operations which are manually selected by a potential purchaser When the single “on/off” switch is actuated to its “on” position, the sound files are broadcast over the speaker according to the playback program which has been manually selected by a potential purchaser.

### BACKGROUND OF THE INVENTION

1. Field of the invention

This invention relates to an interactive packaging system. This invention relates, more specifically, to the marketing and selling of various consumer products, e.g., CDs, DVDs, video cassettes, books, cereal products, prescription drugs, etc., within an interactive package.

One example of such consumer product is a CD with a plurality of music interludes and/or songs thereon. This product requires packaging of some sort to enable sales. In this case, packaging is required not only for product protection, but also, because without appropriate packaging, the product may not even be recognized as a product for sale. In order to address the difficulties encountered in selling such a product, packaging, in store-promotional displays, and audio sampling equipment have traditionally been used. Even known pieces of music, assembled in a new collection, frequently resort to the expensive marketing tool of television advertising campaign. The cost and potential return-on-investment will determine the decision of where to place an advertisement budget. In most cases, that decision carries substantial, non-recoverable expenses.

In the case of CD, there is often the need to provide enhanced information concerning the content of the CD to potential buyers at the point of sale. This has traditionally been met by having the potential purchaser request the playing of the CD from staff within the store. The potential purchaser then puts on a headset to be able to listen to selected parts of the CD. This not only wastes time, but also increases the cost due to the installation of the necessary equipment. Moreover, many CDs are packaged in sealed “jewel boxes” which make it difficult to sell later should the potential customer decline to make the purchase.

2. Description of the Prior Art

WO 0306575, published Aug. 07, 2003, in the names of Hutcheon Morag (inventor) and Origgio Ltd (assignee) discloses a package container including an audio integrated circuit which is capable of converting digital audio data into electrical audio signals, which is connected to, or is integrated with, a memory for providing audio data to the audio integrated circuit. The memory has an input through which digital audio data can be uploaded to the memory. A speaker receives electrical audio signals from the audio integrated circuit for reproducing corresponding sound signals. A battery is connected to power the audio integrated circuit and a manually actuatable switch causes the audio integrated circuit to operate to receive digital audio data from the memory and to provide electrical audio signals to the speaker for reproduction of the audio material.

As described by the inventor, by loading digital data corresponding to samples of one or more tracks of a CD into the memory, a potential purchaser may listen to such tracks by the simple act of manual activation of the switch, and thus can obtain enhanced information without having to open the jewel box.

A serious defect of this system is that, once the switch is activated, all the tracks which have been uploaded must be listened to by the potential purchaser, since no means have been taught to override the activation so as to skip to another selection of a plurality of sound bites on the CD.

U.S. Pat. No. 6,338,405, patented Jan. 15, 2002 in the names of Robert Yoerg et al teaches a protective case for storage media that itself has separately addressable data independent of the storage media which is encased in the protective case. That patent teaches means for the storing, playing and recording of predetermined data. This takes the form of means, which are cooperatively attached to the protective case for storing data, such means being independent and separate and apart from the storage media which is encasable in the protective case. That stored data relates to the content of the data on the storage media, and is independent and separate and apart from the data which is stored on the storage media. The stored data is either in a single block or in distinct addressable segments. Means are provided which are co-operatively attached to the protective case for playback of the separately stored data. Thus, that patentee teaches that, when the data is in distinct addressable segments, a track selection button is used to select a particular segment of the stored data.

A serious defect of such system is that, once the track selection button is used, only the selected segment is played back, since no means have been taught to override the activation so as to skip to another selection of a plurality of sound bites on the CD

U.S. Pat. No. 6,022,262, patented Feb. 8, 2000 in the name of Jennifer Jane Gill teaches a playback system including a speaker mounted on a housing for transmitting audible signals, and a memory connected to the speaker for transmitting the audible signals therefrom. Connected to the memory is an activation switch for playing back audio signals only during the activation thereof. Thus, this patent teaches that the playback system is for playing back only one of a plurality of pre-recorded audio messages. The memory selection button selects one of the predetermined numbers of available memory slots. Depression of the button incrementally selects each memory slot

A serious defect of such system is that once the track selection button is used only the selected segment is played back. No means are taught for overriding the selection, or for automatically playing another selection.

U.S. Pat. No. 4,872,151, patented Oct. 3, 1989 to Smith teaches a compact disc having digitally encoded reproducible data in tracks on the playing side and an editing device for storing the order of play data to control the sequence in which the tracks are played. A special CD reproduction system must be used which is specially equipped to play the CDs having the editing devices thereon.

U.S. Pat. No. 6,229,779 patented May 8, 2001 to Berry et al provides a physical play-in-place case for housing a CD. The case includes a base, a shell attached to the base defining a cavity for receiving the CD. The shell has a landing portion defining a spine area along a common side of the base and shell and a cover hinged to the base along the spine area. Playback controls are located on the landing portion of the shell extend into the spine area. An audio output device is located in the shell. This system merely plays a selection of a track on the CD but not a pre-selected independent segment thereof.

The invention in its general form will first be described, and then its implementation in terms of specific embodiments will be detailed with reference to the drawings following hereafter. These embodiments are intended to demonstrate the principle of the invention, and the manner of its implementation the invention in its broadest sense and more specific forms will then be further described, and defined, in each of the individual claims which conclude this Specification

### SUMMARY OF THE INVENTION

It would therefore be advantageous for a potential purchaser to listen to a sample of music which is recorded on a CD without having to open the protective jewel box package.

It would also be advantageous to provide a protective case for encasing storage media wherein the protective case contains separately addressable data comprising a message regarding the contents of the storage media, or to play a sample of the contents of the storage media without having to open the protective case.

It would also be advantageous to provide a system where information concerning the contents of a sealed protective package may be obtained without the necessity of opening the sealed protective package.

It would also be advantageous to provide a simple protective package for an audio CD which can be used to sample the music on the CD placed within a jewel case without having to remove the CD from the jewel box.

It would also be advantageous to provide a novel playback of information concerning the content of a sealed package so that the playback may be controlled by the user in various alternative programmed ways.

### STATEMENTS OF INVENTION

In one embodiment, the present invention provides a package which includes a container and means within such container to hold storage media, or a product including storage media therewithin. An audio system is operatively associated with such package. The audio system includes a self-contained electrical power source and an on/off switch which is electrically connected to the electrical power source. A read/write controller/memory circuit is electrically connected to the on/off switch. The memory circuit is uploaded with a plurality of selected sound files which are intimately associated with, but which are separate and distinct from, the storage media which is in the package. The processor/memory is also uploaded with a playback program. A speaker is connected to the controller/memory circuit Such playback program may be manually actuated by means of such single “on/off” switch to effect one of the following operations: by a first manual operation of such single “on/off” switch automatically to scroll through, and play back sequentially, the plurality of sound files from the first sound file to the last sound file in the memory; by a second manual operation of such single “on/off” switch to stop the playback, to skip to the second sound file and then automatically to scroll through, and play back sequentially, the plurality of sound files from the second sound file to the last sound file in the memory; by a third manual operation of such single “on/off” switch to stop the playback, to skip to the third sound file and then automatically to scroll through, and play back sequentially, the plurality of sound files from the third sound file to the last sound file in the memory; and to continue such operations until the last sound file is played back. When the on/off switch is actuated to its “on” position, the selected sound files are broadcast over the speaker according to the program which is manually selected by a potential purchaser.

### FEATURES OF THE INVENTION

By one feature of this embodiment of the present invention, the product is a CD, and the audio data comprises a plurality of separate and distinct audio files from the CD.

By a second feature of this embodiment of the present invention, the product is a book, and the audio data comprises a plurality of separate and distinct audio files from the book

By a third feature of this embodiment of the present invention, the product is a package containing a medicine, and the audio data information comprises unique, individually-recorded information relating to the medicine and its dosage.

Thus, in a preferred embodiment of the present invention, the package container includes a processor/memory, powered by a self-contained electrical power source and actuated by a selector switch. The processor/memory is uploaded with a plurality of digitized sound files which are intimately associated with the product in the package. The sound files in the processor/memory are routed via a D/A converter to be broadcast as sounds through a speaker.

It is essential in the present invention that a playback program be incorporated into the processor/memory so that the following action takes place. A first actuation of a single selector switch by a prospective buyer causes all the sound files to be broadcast successively and uninterruptedly from the first sound file to the last sound file in the memory. However, when the single selector switch is actuated a second time, the broadcast of the first selected sound file is interrupted and the second sound file in the memory is then broadcast. This sequence may be repeated to interrupt the playback of the second sound file in the memory, and to scroll to the next sound file in the memory, or the broadcast of the sound files may be continued uninterrupted to the end.

For example, if the sound files are 10 second samplings of each of the 20 tracks on a CD, the first actuation of the single selector switch causes the playing of the sample of the first track. This may continue to the end of the entire 10 second sample of the first track, and then go onto the second 10 second sample of the second sound track, and so on. Alternatively, a second actuation of the single selector switch causes an interruption of the sample of the first track and skips to the 10 second sample of the second sound track. This may continue to the entire sample of the second sound track to its end and the automatic playing of the sample of the third sound track. Alternatively, a third actuation of the selector switch causes an interruption of the sample of the second track and skips to the sample of the third track, which is then played. This sequence may be manually continued under the control of a prospective buyer until all the tracks have been played

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

In the accompanying drawings,

FIG. 1 is a top plan view of a CD jewel box provided with the interactive packaging system according to one embodiment of the present invention;

FIG. 2 is a block diagram of components to be incorporated in the interactive packaging system; and

FIG. 3 is a system overview for the transfer of data to the packages.

### DESCRIPTION OF PREFERRED EMBODIMENTS

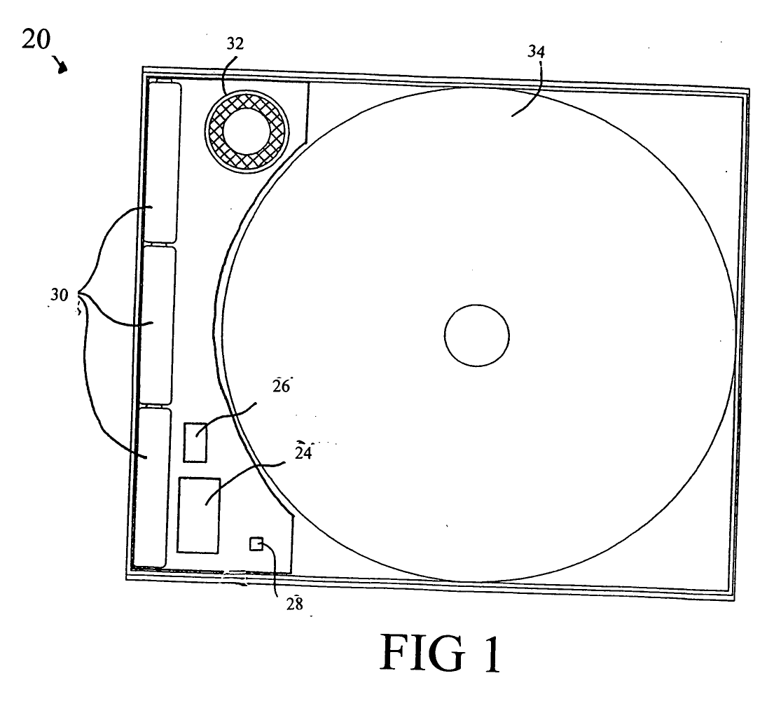

### Description of FIG. 1

FIG. 1 illustrates a top plan view of the jewel box 20 provided with a controller 24, a memory 26 and a trigger switch 24, three batteries 30, a speaker 32 and a conventional area to mount the CD 34. For the embodiment illustrated in FIG. 1, the controller 24 may be the one which is made by Winbond Electronics Corp. under part number W583xxx, the memory 26 may be the one which is made by Winbond Electronics Corp. under part number W55Fxx; and the trigger switch 28 may be made by many manufacturers. One style is carbon contact, a featured in many hand calculators. The three batteries 30, the quad-A style batteries, and the speaker 32 may be the ones which are made by Hy-Q international (Australia) Pty., Ltd. under part number 20CS120M-38ND. Of course, other manufacturer's elements could be used.

Once the CD 34 is installed in the jewel box 20, it is ready to be placed in the store where potential customer will be in a position to depress the trigger switch 38 to activate the circuit and thus initiate the playback of a selected portion of the music CD, which is stored in the memory 26, via the speaker 32.

The size of the memory 26 which is chosen allows a certain period of total playtime at a fixed sample rate. For example, a 512 KB memory yields about 30 seconds at 7 kHz. Should sound samples be of the order of 5 seconds, they could be played as many as 10,000 times given the suggested batteries and parameters.

A protective case for storage media (data storage assembly) in accordance with the teachings of embodiments of the present invention is generally designated by the reference number 100. The protective case 100 illustrated is a protective case for a Compact Disc (“CD”). However, the invention is equally applicable to protective cases for CD-Read Only Memory (“CD-ROM”), CD-Read/Write (“CD-R”), CD-Read/Write/Re-Write (“CD-RW”), Digital Video Disc (“DVD”), Eight Millimeter Movie film, Video Cassette Tape, Video Game Cartridge, and other storage media.

The protective case 100 shown in FIG. 1, comprises three (unnumbered ) parts, namely, the front cover, the back cover with a binding wall and the insert section for the back cover. The back cover and the front cover are attached by protrusions facing inward from the front cover, which fit into corresponding holes on the back cover.

A first system for storing data and a second system for reproducing the separately stored data, may be cooperatively attached to the protective case at the binding wall. In using the term “data”, this description specifically refers to information stored in the protective case which may be either selected sound bites extracted from the enclosed storage media, or descriptive matter concerning the enclosed storage media, and does not refer to data which is itself stored on the storage media. The data may be audible in nature, although electronic, graphic, video and other types of data known in the art are also contemplated.

The first system may comprise one or more Data Record and Playback Modules (“DRPM”), Central Processing Unit (“CPU”), or similar devices. The second system may comprise one or more DRPM, CPU, or similar devices. Moreover, the first system and the second system may be two separate elements, or may be a single DRPM, CPU; similar devices may provide the first system and the second system. In addition to other forms of data, the data may include sound which is audible when reproduced, or which is beyond the range of human hearing.

Data which is stored in the first system may be volatile or non-volatile, analog or digital. The first system may have data pre-recorded on it. There are many known ways in the art for pre-storing data, e.g., the method by which CDs are currently pre-programmed with music. Furthermore, data may be recorded, stored and reproduced in distinct addressable segments within a DRPM, CPU or similar device(s) which is separate and distinct from that stored on the storage media itself.

Preferred batteries, given the “jewel box” form of this embodiment of the present invention, are button cells or quad-A style cylindrical batteries. In order to operate traditional LEDs, the minimum required voltage is about 1.8 Volts. A chemical battery, e.g., Li-ion, Li-metal, or the like, can provide voltage well in excess of the required minimum from a single cell. Most battery chemistries (alkaline batteries etc.) provide 1.5 Volts or less from a single cell. Electronic pumping by switched capacitors, etc., can provide the required voltage from lower voltage sources. Two or more alkaline batteries connected in series can provide high enough voltages also. Two or more batteries connected in parallel can provide additional energy onboard a package. Any of the above-described sources can provide longer times of operation by suitable power management, etc.

Alkaline quad-A batteries (e.g., those known by the Trade-marks Energizer, Duracell, etc.) provide over 450 mA per battery, which can produce over 6 hours of sound playtime. Such sound play can reach 75 mA current while maintaining a combined voltage of 1.8V or more. This way, a total electrical power supply of well over 100 mW electrical power is available. Two columns of 3 quad-A style batteries can still be fitted when the content of the jewel box is one or more CDs.

Micro-speakers are available now (e.g., those known by the Trade-mark Hy-Q) with efficiencies of up to 90 dB should pressure level (SPL) at a distance of 10 cm given an electrical power input of 100 mW. The acoustical volume of normal speech is about 50-70 dB SPL. Therefore, the proposed power supply and speakers can overcome normal in-store noise levels easily. The power supply can be managed electronically such that 30 to 50 mW electrical input to efficient micro-speakers are supplied over the life of the power supply. That provides sufficient acoustical volume and sound quality given appropriate micro-speakers.

The package allows traditional round dynamic speaker(s) with sizes of up to about 30 mm diameter and up to about 10 mm in height from current, mass-produced offerings. Alternatively, advanced surface actuators, or transducers, array speakers, micro-machines, etc., can be used also. The choice of speaker(s) is made in order to optimize the sound that can be produced, given the constraints of space, energy, efficiency, cost, etc. Space and available energy, more than other factors, limits the sound produced at low frequencies. As a compromise, low frequency content of the sound track may be restricted on purpose by filtering it out at any stage before reproduction. This way valuable energy can be saved that would not produce much of low frequency acoustic waves anyway because of the size limitation.

Sound to be produced is generally stored digitally, even though semi-analog or other forms of storage may be suitable. Sampling, storage, and reproduction of high frequency acoustic waves increase the data volume of a sound track representation and increase memory requirement. In order to reduce the cost of memory and the cost of high performance speakers, high frequency content of the sound track may also be curtailed at any stage before reproduction due to the physiology of hearing. It may be advantageous to focus on a frequency range of approximately 400 Hz to approximately 7000 Hz. Speakers can be chosen that reproduce this range as efficiently and as uniformly as possible. The sound track can be filtered in order to eliminate frequencies outside this range. Within the chosen frequency range, the sound track may be enhanced artificially in order to compensate for the chosen speaker's natural sound characteristics such that the reproduced should achieve the best quality. Such enhancements and frequency compensations can be applied to the sound tracks by using conventional off-the-shelf music editing software for PC, for example.

The famous Nyquist criterion requires digital data sampling frequencies of 12,000 Hz or more in order to reproduce acoustical frequencies of 6000 Hz or more. Each data sample can be represented by 7 bits, 8 bits, or more bits for high quality sound. This implies memory requirements of the order of 1 megabit, or more. Memory of 1 megabyte should allow for about 1 minute of high quality sound playtime. Much more non-volatile memory can be fitted and has become relatively affordable in mass-quantities. This allows the package to play minutes worth of sounds several hundred times from onboard memory and from onboard energy supply. Efficient modem processors require only currents of the order of a few milli-amperes or less.

Microprocessors are available that are fully integrated onto a single chip for a particular application. Those chips can incorporate functions of A/D, D/A conversion, power management, non-volatile data storage, etc. Those chips also provide ports that allow external inputs (e.g., that known by the Trade-mark WINBOND CHIPCORDER). Other microprocessors are available to provide general purpose computing capabilities for many applications at low prices by software adaptation.

Both application-specific integrated circuits -ASIC, and general-purpose microprocessors can be used to provide functionality for a package. Each requires a down-load process to store data in memory.

The interactive nature of the package is created by the onboard electronics. This can be achieved by firmware or by software. The method is interactivity through software responding to input from a single “on/off” switch. A read/write controller/memory circuit is electrically connected to the single “on/off” switch. The read/write controller/memory circuit is uploaded with a plurality of pre-selected sound files which are intimately associated with, but are separate and distinct from, the storage media. As will be described in greater detail hereinafter, when the single “on/off” switch is actuated to its “on” position, the sound files are broadcast over the speaker according to the program which has been manually selected by a potential purchaser.

Volume control through software upload is preferable for mass production applications. This keeps the interactivity simple and intuitive. However, volume control as part of the interactivity may be required for hearing impaired users.

Many possible styles of selectors (e.g., inductive, capacitive, resistive, infrared, inertia, mechanical, conducting polymer, conducting fluid, pressure, etc.) may be chosen. One style of selector with a number of advantages is a phototransistor. It can be mounted just like other required electronic elements thereby reducing the number of manufacturing steps. It can be quite small, low cost, sensitive, very reliable, well protected, etc.

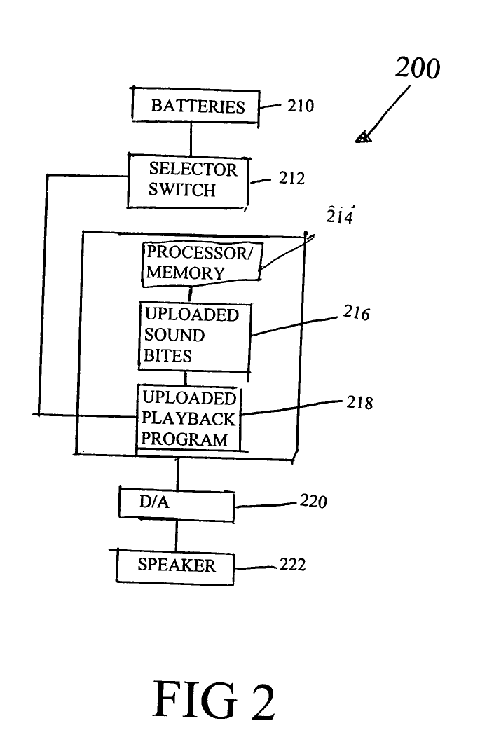

### Description of FIG. 2

As seen in FIG. 2, the system generally identified as 200 includes a processor/memory 214, which includes the following components: a so-called “voice chip” or audio integrated circuit in the form of a digital voice synthesizer chip to which a memory, e.g., a flash memory a software playback processor and an amplifier are connected. These three components may be provided in a single specified integrated circuit, shown generally as 212, but may be discrete individual components. Power is provided to the voice chip and the amplifier from batteries 210. The amplifier feeds a speaker 222. The voice chip and amplifier are activated by a single selector switch 212 by way of the uploaded playback program 218. The sound files which are manually selected are processed by the software playback processor from the uploaded sound files 216 to the speaker 222 via a D/A converter 220. The software playback program, is manually actuated by means of the single “on/off” switch 212 to effect one of the following operations: 1) when the single “on/off” switch 212 is actuated, the playback program automatically scrolls through, and plays back in sequence, the entire plurality of sound files from the first sound file to the last sound file in the memory; 2) when the single “on/off” switch 212 is actuated a second time, the playback program stops and then skips to the second sound file and then automatically scrolls through, and plays back in sequence, the plurality of sound files from the second sound file to the last sound file in the memory; 3) when the single “on/off” switch 212 is actuated a third time, the playback program stops and then skips to the third sound file and then automatically scrolls through, and plays back in sequence, the plurality of sound files from the second sound file to the last sound file in the memory; and x) when the single “on/off” switch 212 is actuated an “x”th time, the playback program stops and then skips to the “x”th sound file and then automatically scrolls through, and plays back in sequence, the plurality of sound files from the “x” sound file to the last sound file in the memory. Thus when the single “on/off” switch 212 is actuated to its “on” position, the sound files are broadcast over the speaker according to the program which has been manually selected by a potential purchaser.

Processor/memory 212 may be a random access memory (RAM), a flash memory, or a one-time programmable memory, e.g., an EPROM, and may be part of the voice chip. Digital data corresponding to samples of one or more tracks of a CD are uploaded at 216 into the processor/memory 212. These samples may be listened-to by a potential purchaser by the manual actuation of the single selector switch 212 on the jewel box. Thus, enhanced information can be provided to the potential purchaser

The storage media may be CD, CD-ROM, CD-R, CD-RW, DVD, Eight-Millimeter Movie Film, Video Cassette Tape, Video Came Cartridge and combinations thereof. The means for storing data may be Data Record Playback Module (“DRPM”), Central Processing Unit (“CPU”), Random Access Memory (“RAM”), Read Only Memory (“ROM”), Programmable Read Only Memory (“PROM”), Erasable Programmable Read Only Memory (“EEPROM”), Electronically Erasable Programmable Read Only Memory (“EEPROM”) and combinations thereof. The means for reproducing the separately stored data may be DRPM, CPU, RAM, ROM, PROM, EPROM and EEPROM and combinations thereof.

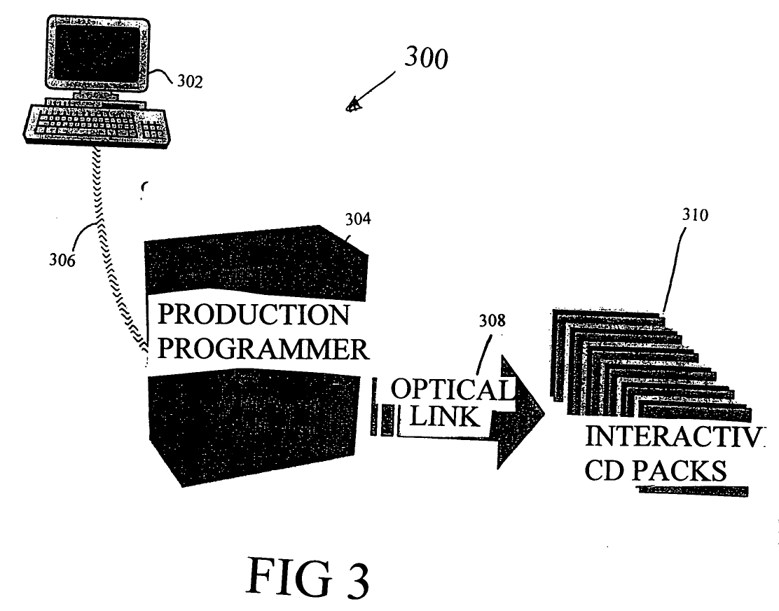

### Description of FIG. 3

Turning now to FIG. 3, a programming system 300 will be described. The programming system 300 includes four main components, namely, a computer 302 running a program, a production programmer 304, and a stereo cable 306 linking the computer 302 to the production programmer 304.

A program run by the computer 302 allows the manufacturer to select the portions of the song/sound that will be uploaded in the memory of the package. According to this embodiment of the programmer system, this information is coded in sound files that may be transferred to the reproduction programmer via a simple stereo cable 306 connected to the computer 302. This allows any computer to be used without the need of specialized I/O cards or devices.

In this embodiment of the system of the present invention, the transfer from the production programmer 304 to the interactive packages is done optically by optical link 308 to the interactive CD packs 310. One of the function of the production programmer is thus to convert the sound file combining through the stereo cable 306 into a digital file by A/D conversion. The production programmer stores the digital file for subsequent upload into the interactive packages at real time speed or at higher speeds, via an optical link, for example. The production programmer 304 digitizes the sound files and then uploads the digitized sound files into the interactive packages via conventional methods that will not be further described herein.

As can be seen from FIG. 3, to improve the mass-production throughput of the unloading process, the digitized sound files are stored in the production programmer and can be uploaded in parallel to more than one interactive package at a time. Of course, when a digital link is used to upload the digitized sound files in the interactive packages, the circuitry of the packages includes the required elements to receive the optical information and convert it into electrical signals to be stored in memory.

The interactive packages are therefore all made identical and may be “customized” by the manufacturer of the content of the package by uploading audio and video data therein. It is therefore possible to mass-produce identical interactive packages.

### VARIATIONS OF THE INVENTION

The packaging containers can be of almost any description. For example, packaging may be applied to books. The digital data held in the replaceable memory may be passages from the book, or other descriptive material related to its contents. Instructions for the use, or other information about other consumer products may be provided. Such instructions may be, e.g., instructions for the use of medicines.

Many modifications may be effected to the conventional CD jewel box, among them are the following:

1) The internal space may be increased, while at the same time reducing cost and assembly work, by eliminating the hub carrier piece; 2) where desired, a different piece can be added with the purpose of forming a battery/speaker compartment; 3) a permanently “open” package could be designed where the package as a single piece; 4) a disposable regenerated cellulose wrapper would typically be added to enclose the CD and the package; 5) the base plate can provide flexing protrusions that put pressure on the batteries and their contacts; 6) the base place can provide protrusions that hold and position the content (products); 7) the cover plate can provide protrusions also in order to hold and position content (products); 8) the base plate, spine, etc., may provide perforations in various locations in order to let the sound waves of the speaker(s) emanate with little loss, low reflections, etc; 9) the base plate may vary in thickness in certain areas; this could be used as indentations to accommodate the curvature of the batteries; 10) the thickness of the base plate may be varied where electronic components need to be embedded yet protected from the outside; 11) the base plate may be thickened to provide additional mechanical strength (for example over speaker(s)) or to provide guide/glide surfaces for the easy insertion of the circuit board; 12) the base plate, spine and cover can be covered with a sticky applique; 13) graphic designers can use this applique in order to provide illustrations, descriptions, bar coding, or any other display suitable for effective product packaging; 14) a regenerated cellulose-type wrapper can be added around the whole package as is common with jewel boxes on sale; the applique and the regenerated cellulose-type wrapper around the whole package can provide cutouts to help transmission of light and sound; 15) such openings can be achieved mechanically or by application of heat; the applique and/or regenerated cellulose can be used to change the color and appearance of the light transmission (filtering, scattering, shadowing, etc.); 16) the base plate and other components can be shaped to help the acoustic properties of speaker(s); 17) the package can have foam inserts or other acoustic materials to help the sound transmissions; j18) foam and or other inserts can be added to the package in order to help the mechanical characteristics of the whole package, e.g., support of components, protection against, or support of applied pressure, reduction of vibration and shock; 19) the interactive package can be metallized or have metal shields to eliminate electromagnetic interference, and/or heat distribution; 20) printed inlays and or booklets can be used for additional marketing effects, or mechanical or electrical insulation, as coverings; 21) a thin cardboard inlay can be used to cover the printed circuit board, batteries), speaker(s), etc., in order to hide, cover, and protect the components further, or to provide easily customizable additional display and information surfaces; 22) integrated circuits and other components can be in die form and can be wire bonded with subsequent droplets of adhesives, insulation, stabilization; 23) sound effects can be added on cereal boxes, chocolate boxes or the like; 24) can be installed in humidors to indicate that water should be added therein; 25) can be installed on any type of filters (water, oil, air) to indicate the best before date; 26) gas masks can provide instructions and best before dates; 27) multi-component adhesives may include mixing instructions; 28) paints, detergents, and other chemicals may include usage instructions; 29) do-it-yourself products like furniture, toys, car parts, etc. can include assembly instructions; 30) goods may be “child-proofed” to emit a sound when there is unauthorized use; 31) software and computer peripherals may include installation instructions; 32) cameras, telescopes, etc. may include installation instructions; 33) roller blades and other sporting goods may include usage instructions and warnings; 34) camping equipment may include usage instructions; 35) pet products may include usage instructions; 36) hair coloring, hair removal, and other cosmetic products may include usage instructions; 37) gardening products may include usage instructions; 38) medical products may include usage instructions and warnings; 39) military products like ammunition, mines, grenades, etc., may include usage instructions and warnings; 40) any packaging, that, when opened, requires transfer of information from the manufacturer to the client may include transfer instructions; and 41) the manufacturer of the interactive packages of embodiments of the present invention may upload a temporary test pattern into the packages before shipping them to the manufacturer of the content.

As described hereinabove, for mass-production and copyright protection by the user of the package, the content of memory (sound track, light functions, programs, settings, features, etc.) is unloaded after the circuitry has been installed into the generic package. The customer of the package performs this upload. Traditional unloading (sometimes called “burning”) of programs, parameters, data, functionality, etc. into an integrated circuit's memory is done by electrical chip programmers. Such programmers with suitable software and “burners” are commonly available and in general use for quite some time. The uploading of programs, parameters, data, etc., can be done easily through electrical contacting of the PCB. Such contacts can be by pins or connectors at any stage of production. It could be done before assembly into the package, or afterward. It could be done before assembly into the case or afterward. It could be done through openings in the closed package or when the package is open. It could be done with onboard power supply or with external power supply.

As discussed hereinabove, the embodiment of the present invention as described above does not use electrical contacting of the PCB for various reasons. Rather, the uploading of programs, parameters, data, etc., into the blank package should preferably be done by an optical link. Such optical link could be a duplex (bi-directional for error checking, status control, etc.) or could be a simplex upload (one-way write to memory). A duplex optical link requires more onboard energy during programming since a high-speed light source needs to be driven by the package. It is customary to confirm an upload process in real time and to initiate the re-sending of data when an error was detected. A duplex optical link may be required in critical applications.

For non-critical applications, the upload process can be simplex. A simplex optical link can be established by using only one upload detector and optical receiver onboard the package. Two optical upload detectors and receivers can be put onboard each package. Such parallel simplex links can be lower cost than a full duplex optical link while offering similar reliability and error correction at high speeds.

Optical upload eliminates alignment, repeatability, reliability, interference and other potential issues especially during mass-production associated with electrical contact programming. Optical “connectorization” is free of wear and tear. Optical transmission can be faster over greater distances than traditional electrical transmissions. The optical connection between the upload equipment and a package by use of surface mounted photodetectors can be less expensive than an electromechanical connection. An electromechanical connection in a mass-production environment would require precision tools and/or a robot. An optical “connection” is unbreakable in comparison with miniature electromechanical connectors. Another advantage is that an optical upload can be easily parallelized at low cost. This way, many packages can be programmed simultaneously with the same information.

Traditional electro-mechanical uploads into “CHIPCORDERs” occurs in “real-time”. This requires approximately the same amount of time for the upload of the portion of the sound tract as it takes to play that portion of the sound track back. For mass production, the preferred embodiment speeds up this upload process. The upload can take advantage of the maximum level of bit-rate transfer available to the on-board microprocessor and to the on-board memory. Therefore, it may be preferred to operate the microprocessor during upload operation at a higher clock frequency than that of normal, energy efficient, operation during play back, or at other times.

As mentioned hereinabove, even though the previous description dealt with interactive CD packages, other products could be packaged in an interactive package according to the present invention. In the case of packaged medications, this interactive package enables a pharmacist to include voice instructions, and audible alarms for visually impaired patients. The pharmacist would be supplied with identical interactive packages and with a programmer system. Once the medication is inserted into the package, the pharmacist may select the time at which the medication must be taken and upload this information into the package.

Another example of use on the interactive packages of embodiments of the present invention involves sports cards. In this case, the interactive packages of embodiments of the present invention can add value by storing a sensational sound bite from the athlete's career in the card's container.

### CONCLUSIONS

As will be apparent to one skilled in the art, interactive packages present may advantages. Examples include the following.

Sampling sound bites, stored in the package, enables a prospective consumer to screen through many offerings quickly and effortlessly.

Interactive packaging allows intellectual property owners, manufactures, distributors, and retail outlets to disclose the information they must disclose, not just in “fine print”, or, disclose the information they wish to disclose, not just in “fine print”, or, disclose the information they wish to disclose, not just in large print. Rather, the package allows communication with consumers by sounds, sights, and additional means at an unprecedented level. Any intended communication requires attention. “Fine Print” some times achieves t he opposite of drawing attention. This invention can help achieve the goal intended by disclosure. Warning sounds and words, that draw the attention of the designee, can be produced. This invention enhances the disclosure of required warnings, proposed instructions, or desired advertisements by presenting it in a customizable form in any language, that provides protection, sights, and sounds.

Given an interactive blank package of low cost, the promotional character specific to each product can be imprinted at the time of packaging and bar coding of each product. The promotional characteristics become a permanent part of the product by way of its package. The package can even be reprogrammed, recharged, and reused when the packages' content is exchanged. The blank packages can be programmed to adapt to many articular products. This is done by the owner of the product in his own packaging plant at low cost and with great ease. Small marketing departments or even individuals, whom wish to make their own content (e.g, burn CDs) as marketing handouts or gifts, can use this system since it requires only an uploading machine, and since the blank packages can be low cost due to large volume production.

The foregoing has constituted a description of specific embodiments showing how the invention may be applied and put into use. These embodiments are only exemplary. The invention in its broadest, and more specific aspects, is further described and defined in the claims which follow.

These claims, and the language used therein are to be understood in terms of the variants of the invention which have been described .They are not to be restricted to such variants, but are to be read as covering the full scope of the invention as is implicit within the invention and the disclosure that has been provided herein.

From the foregoing description, one skilled in the art can easily ascertain the essential characteristics of the present invention and, without departing from the spirit and nature of the present invention can make various changes and modifications of the present invention to adapt it to various usages and conditions. Consequently, such changes and modifications are properly, equitably, and “intended” to be, within the full range of equivalence of the folloeing claims.

1. A package comprising:
A) a container;
B) structure within said container to hold at least storage media therewithin; and
C) an audio playback combination operatively associated with said package, said audio playback combination comprising
a) a self-contained electrical power source;
b) a single “on/off” switch electrically connected to said electrical power source;
c) a speaker connected to said controller/memory circuit; and
d) a read/write controller/memory circuit electrically connected to said single “on/off” switch, said read/write controller/memory circuit being uploaded with a plurality of pre-selected sound files which are intimately associated with, but are separate and distinct from, said storage media, said circuit being uploaded with a software playback program, said playback program being manually actuated by means of said single “on/off” switch to effect one of the following operations: by a first manual operation automatically to scroll through, and play back in sequence, the entire plurality of sound files from the first sound file to the last sound file in the memory; by a second manual operation to cease said scrolling and to skip to the second sound file and then automatically to scroll through, and play back in sequence, the plurality of sound files from the second sound file to the last sound file in the memory; by a third manual operation to cease said scrolling and to skip to the third sound file and then automatically to scroll through, and play back in sequence, the plurality of sound files from the third sound file to the last sound file in the memory; and to continue such operations until the last sound file is played back;
whereby:
when said single “on/off” switch is actuated to its “on” position, said sound files are broadcast over said speaker according to the program which has been manually selected by a potential purchaser.

2. The package of claim 1, wherein said storage media is intimately associated with a CD, and wherein said audio data comprises a plurality of audio files reproduced from said CD.

3 The package of claim 1, wherein said storage media is intimately associated with a book, and wherein said audio data comprises a plurality of audio files reproduced from said book.

4. The package of claim 1, wherein said storage media is intimately associated a package containing a medication, and wherein said audio data information comprises unique, individually-recorded information relating to said medication and its dosage.
